(19) United States
(12) Patent Application Publication
(10) Pub. No.: US 2018/0104823 A1
(43) Pub. Date: Apr. 19, 2018

(54) COMMUNICATION DEVICE

(71) Applicant: TOYOTA JIDOSHA KABUSHIKI KAISHA, Toyota-shi (JP)

(72) Inventor: Wataru KAKU, Nagoya-shi (JP)

(73) Assignee: TOYOTA JIDOSHA KABUSHIKI KAISHA, Toyota-shi (JP)

(21) Appl. No.: 15/722,567

(22) Filed: Oct. 2, 2017

(30) Foreign Application Priority Data
Oct. 13, 2016 (JP) 2016-202065

(51) Int. Cl. B25J 11/00; G06N 3/00; G10L 15/22; G06K 9/00

(52) U.S. Cl. CPC B25J 11/0015; G06N 3/008; G10L 2015/226; G06K 9/00221; B25J 11/001; G10L 15/22

(57) ABSTRACT

A communication device includes a face portion having a pair of eye portions; light-transmissive covers each covering a corresponding one of the pair of eye portions; a display panel configured to display a design in which expression of an eye is stylized; an optical fiber bundle configured to transmit the design displayed on the display panel to the light-transmissive covers; and a control unit configured to selectively display the design on the display panel.

### INCORPORATION BY REFERENCE

The disclosure of Japanese Patent Application No. 2016-202065 filed on Oct. 13, 2016 including the specification, drawings and abstract is incorporated herein by reference in its entirety.

### BACKGROUND

### 1. Technical Field

The present disclosure relates to a communication device.

### 2. Description of Related Art

Robots that communicate with users have been becoming more and more familiar. In terms of enhancing communication ability, there have also been known many robots having a face portion resembling that of a human being or an animal. There have also appeared robots having a display panel in a face portion so as to display expression of eyes in a stylized manner (see, e.g., Japanese Patent Application Publication No. 2016-103277 (JP 2016-103277 A)).

### SUMMARY

When a flat display panel is directly disposed in a face portion, a robot does not look like a human being or an animal. On the other hand, when an eye portion is made of a transparent resin with a curved surface and a flat display panel is disposed behind the eye portion, a gap is inevitably formed between the resin and the panel, so that, depending on a positional relationship between a robot and a user, the visibility is lowered due to positional deviation, refraction, or the like of a displayed design.

The present disclosure provides a communication device that displays an expressive design at an eye portion with high visibility.

A communication device according to one aspect of the present disclosure includes a face portion having a pair of eye portions; light-transmissive covers each covering a corresponding one of the pair of eye portions; a display panel configured to display a design in which expression of an eye is stylized; an optical fiber bundle configured to transmit the design displayed on the display panel to the light-transmissive covers; and a control unit configured to selectively display the design on the display panel.

With the configuration described above, since a plane onto which the design is actually projected approximately coincides with a light-transmissive cover plane, it is reduced that the design is deviated in position or distorted due to refraction or the like depending on the position of observing the communication device.

The present disclosure provides a communication device that displays an expressive design at an eye portion with high visibility.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is an outline view of a robot according to an embodiment;

FIG. 2 is a system configuration diagram of the robot;

FIG. 3 is a perspective view showing the structure of a right eye;

FIG. 4 is a plan view showing a positional relationship between pixels and optical fibers;

FIG. 5 is a schematic diagram showing another example of an eye portion;

FIG. 6 is a diagram showing a state where a dialogue partner has moved to the right side in a captured image;

FIG. 7 is a diagram showing a state of an eye portion where the line of sight is directed to the dialogue partner on the right side;

FIG. 8 is a diagram showing a state of the entire face portion where the line of sight is directed to the dialogue partner on the right side;

FIG. 9 is a flowchart showing the sequence of the display process;

FIG. 10A is a diagram for explaining a variation of a design to be displayed;

FIG. 10B is a diagram for explaining a variation of a design to be displayed;

FIG. 10C is a diagram for explaining a variation of a design to be displayed;

FIG. 10D is a diagram for explaining a variation of a design to be displayed; and

FIG. 10E is a diagram for explaining a variation of a design to be displayed.

### DETAILED DESCRIPTION OF EMBODIMENTS

The present disclosure will be described hereinbelow with reference to an embodiment, which, however, is not intended to limit the present disclosure to the following embodiment. Further, all configurations which will be described in the following embodiment are not necessarily essential as means for solving the problem.

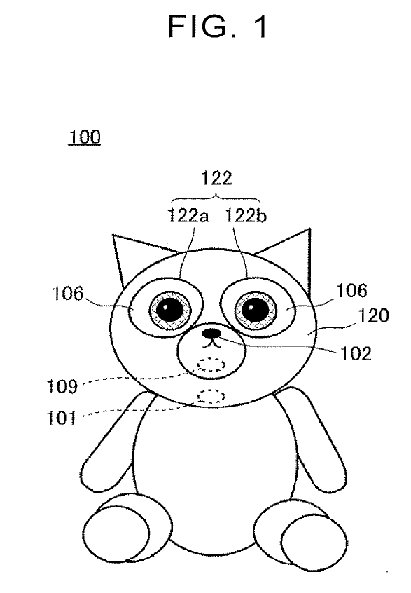

FIG. 1 is an outline view of a robot 100 according to this embodiment. The robot 100 is a robot as a communication device that carries out a voice dialogue with a human being as a user. The robot 100 changes expression of its eyes according to a voice dialogue.

The robot 100 has an external appearance resembling an animal and includes a face portion 120. The face portion 120 is provided with an eye portion 122 (a right eye 122a and a left eye 122b) at a position where the user can recognize them as eyes. While the structure of the eye portion 122 will be described in detail later, display panels 106 are respectively disposed in the back of the right eye 122a and the left eye 122b.

A camera 102 is inconspicuously disposed at the position of a nose of the robot 100. The camera 102 includes, for example, a CMOS sensor and functions as an imaging unit that captures an image for recognizing an external environment. A loudspeaker 109 is disposed in a concealed manner at the position of a mouth of the robot 100. The loudspeaker 109 functions as a speech output unit that emits a voice generated by the robot 100. When the user hears a voice that is output from the position of the mouth, the user feels as if the robot 100 is talking. Further, a microphone 101 is disposed in a concealed manner at an appropriate position of the face portion 120. The microphone 101 functions to collect a speech voice or the like of the user.

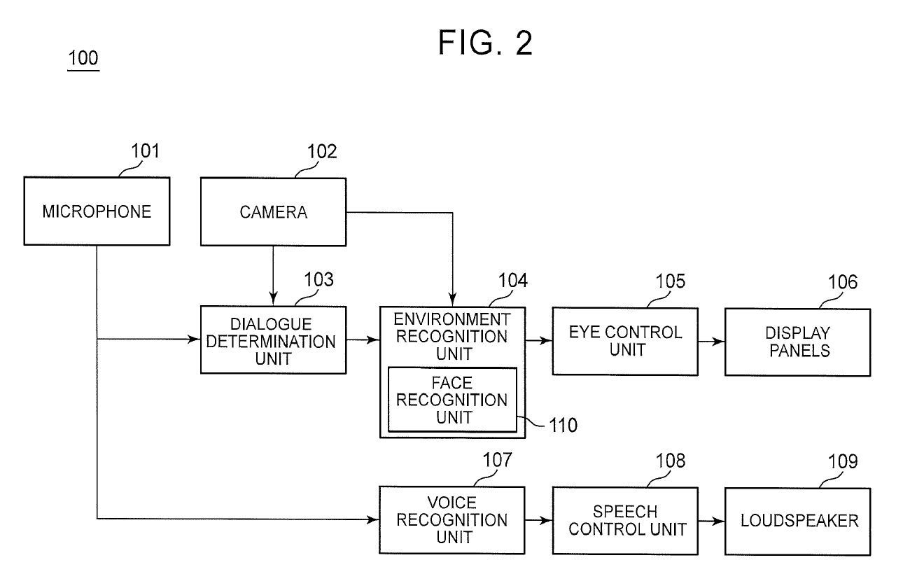

FIG. 2 is a system configuration diagram of the robot 100. The robot 100 includes, as a main system configuration, the microphone 101, the camera 102, a dialogue determination unit 103, an environment recognition unit 104, an eye control unit 105, the display panels 106, a voice recognition unit 107, a speech control unit 108, and the loudspeaker 109.

As described above, the microphone 101 collects a voice such as a speech voice of the user. The camera 102 captures an image of the user and a surrounding environment of the user and produces image data.

Based on the collected voice collected by the microphone 101 and the captured image captured by the camera 102, the dialogue determination unit 103 determines whether or not the robot 100 is in dialogue with the user. When the volume of the collected voice has exceeded a threshold value and the user is appearing in the captured image, the dialogue determination unit 103 determines that the robot 100 is in dialogue with the user.

When the dialogue determination unit 103 has determined that the robot 100 is in dialogue with the user, the environment recognition unit 104 recognizes the user and the surrounding environment of the user appearing in the captured image captured by the camera 102. The environment recognition unit 104 includes a face recognition unit 110. The face recognition unit 110 recognizes a position of a face of the user appearing in the captured image. For example, based on feature points of the face of the user appearing in the captured image, the face recognition unit 110 can recognize the position of the face of the user.

For example, the face recognition unit 110 can specify as a user a person appearing in a captured image at the start of a dialogue and can continue to pursue the specified user. The face recognition unit 110 may specify as a user a person whose face size is the largest among persons appearing in a captured image (i.e. a person located at a position closest to the robot 100). When determining whether or not an object appearing in a captured image is a person, the face recognition unit 110 may use a face recognition technique that is employed in a digital camera or the like. The face recognition unit 110 may specify a user using a difference with respect to a background image (an image of an installation environment where the robot 100 is installed) captured in advance by the camera 102. The face recognition unit 110 may search for a user by limiting to an image region obtained as the difference.

As will be described later, the display panels 106 are respectively disposed in the back of the eyes of the robot 100 and each display a design in which expression of the eye is stylized. Each display panel 106 is, for example, a liquid crystal panel or an organic EL panel.

Based on the position of the face of the user recognized by the face recognition unit 110, the eye control unit 105 directs the line of sight of the eyes displayed on the display panels 106 toward the position of the face of the user. Further, depending on the change in dialogue content or in surrounding environment, the eye control unit 105 dynamically changes expression of the eyes displayed on the display panels 106. Specific changes will be described later.

The voice recognition unit 107 performs voice recognition of the collected voice collected by the microphone 101. When the speech voice of the user has been voice-recognized by the voice recognition unit 107, the speech control unit 108 produces a response sentence to the speech voice of the user. For example, the speech control unit 108 holds a database in which user speech contents and response sentences thereto are correlated with each other in advance, and using this database, the speech control unit 108 produces the response sentence corresponding to the user speech content. The loudspeaker 109 outputs in voice the response sentence produced by the speech control unit 108.

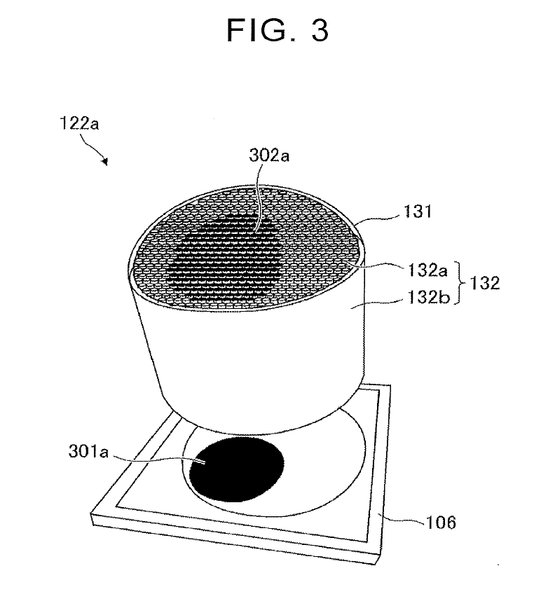

FIG. 3 is a perspective view showing the structure of the right eye 122a. The left eye 122b has the same structure as the right eye 122a, and the respective display panels 106 thereof are display-controlled by the eye control unit 105.

The right eye 122a is mainly composed of a light-transmissive cover 131, an optical fiber bundle 132, and the display panel 106. The light-transmissive cover 131 is made of, for example, transparent polycarbonate and serves as an armoring member of the face portion 120. In the case of a robot resembling an animal or a human being, the surface of an eye being a curved surface is natural and readily acceptable to a user. Therefore, also in the robot 100 of this embodiment, the light-transmissive cover 131 corresponding to the surface of the eye is formed as a curved surface convex outward.

The display panel 106 for displaying a design in which expression of the right eye is stylized is disposed in the back of the right eye 122a. A display surface of the display panel 106 is a flat surface. The display surface has a size large enough to embrace the outer periphery of the light-transmissive cover 131. FIG. 3 shows a state where a display right eye diagram 301a, representing a design in which a black eye is eccentrically superimposed on a white eye having a size corresponding to that of the outer periphery of the light-transmissive cover 131, is displayed.

Herein, when the display panel 106 whose display surface is the flat surface is disposed behind the light-transmissive cover 131 formed by the curved surface, a gap is inevitably formed between them. If this gap is present as a space, when, for example, a user observes the right eye 122a from an oblique direction, the light-transmissive cover 131 as the armoring member and the displayed display right eye diagram 301a are deviated from each other, and depending on the case, there is a possibility that an internal circuit or the like may be seen through a peripheral portion of the light-transmissive cover 131. Depending on the case, there is a possibility that the displayed display right eye diagram 301a may be seen with part of it missing. Further, there is a possibility that the displayed display right eye diagram 301a may be refracted or reflected by the light-transmissive cover 131 so as to be seen distortedly or blurredly. Therefore, in the robot 100 of this embodiment, the optical fiber bundle 132 for transmitting the display right eye diagram 301a displayed on the display panel 106 to the light-transmissive cover 131 is interposed between the light-transmissive cover 131 and the surface of the display panel 106.

The optical fiber bundle 132 is an aggregate of optical fibers 132a that are in one-to-one correspondence with pixels of the display panel 106. Although the optical fibers 132a are shown to be spaced from the surface of the display panel 106 in FIG. 3 for convenience of description, one ends of the optical fibers 132a are bonded to the surface of the display panel 106 by a light-guide adhesive. The other ends of the optical fibers 132a are cut to follow an inner curved surface of the light-transmissive cover 131. An end face of the other end of each optical fiber 132a may be perpendicular to an extending direction of the optical fiber 132a or may be polished to a curved surface matching the inner curved surface of the light-transmissive cover 131. The other ends of the optical fibers 132a are bonded to the inner curved surface of the light-transmissive cover 131 by a light-guide adhesive.

The optical fibers 132a are bundled into an aggregate with its outer peripheral surface being coated with a coat 132b. In order to prevent stray light, the coat 132b is preferably made of a light-shielding material. In this way, the light-transmissive cover 131, the optical fiber bundle 132, and the display panel 106 are connected and integrated together.

The light flux of the display right eye diagram 301a displayed on the display panel 106 enters from the one ends of the optical fibers 132a and exits from the other ends of the optical fibers 132a. An aggregate of the other ends, serving as light exit surfaces, of the optical fibers 132a forms a virtual screen that follows the inner curved surface of the light-transmissive cover 131. Therefore, the display right eye diagram 301a displayed on the display panel 106 is projected onto this virtual screen so as to be converted to a projection right eye diagram 302a. Since the projection right eye diagram 302a follows the inner curved surface of the light-transmissive cover 131, the user can observe the projection right eye diagram 302a from various angles without partial missing, without distortion, and without blurring.

The other ends, that form the virtual screen, of the optical fibers 132a may be subjected to a surface roughening treatment so as to diffuse outgoing light. Alternatively, a surface roughening treatment may be applied to the surface of the light-transmissive cover 131 so that outgoing light is diffused through the light-transmissive cover 131. With the surface roughening treatment, the projection right eye diagram 302a is observed as a smoother design.

The light-transmissive cover 131 is not necessarily colorless and transparent, but is satisfactory if at least part of outgoing light from the optical fibers 132a is transmitted therethrough. Therefore, the light-transmissive cover 131 may be colored in terms of attaching importance to the ornamentation of the face portion 120. The light-transmissive cover 131 is not necessarily formed as the curved surface in its entirety and may be partially formed as a flat surface for matching a feature of an eye of an imitation object. In this case, the other ends of the optical fibers 132a, when included in a region corresponding to a curved surface, may be processed to match such a curved surface.

The display right eye diagram 301a displayed as a flat surface is converted to the projection right eye diagram 302a projected as a curved surface. Therefore, preferably, the eye control unit 105 adjusts in advance the shape of the display right eye diagram 301a to be displayed so that the projection right eye diagram 302a to be observed may have an adequate shape. In this case, for example, even for a design of a single black eye, the eye control unit 105 adjusts its position and shape to be displayed depending on which position on the virtual screen the design is to be projected at.

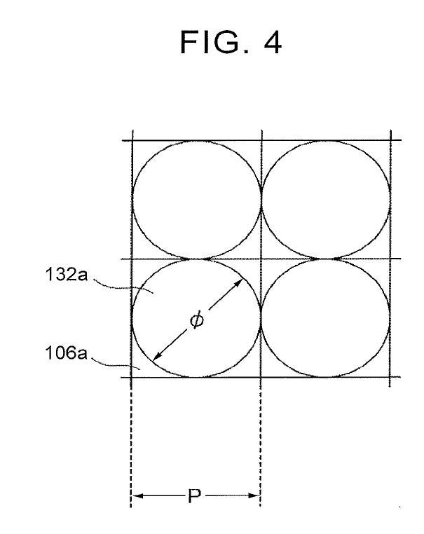

FIG. 4 is a plan view showing a positional relationship between pixels 106a, which are display pixels of the display panel 106, and the optical fibers 132a. As shown in FIG. 4, the pixels 106a are arranged two-dimensionally in a grid pattern. The optical fibers 132a are arranged such that an incident surface of each optical fiber 132a is inscribed in the corresponding pixel 106a. That is, assuming that the outer diameter of each optical fiber 132a is ϕ and that the pitch of the pixels 106a is P, a relationship of P=ϕ is established. With this arrangement, since each optical fiber 132a transmits a light flux of one pixel, it is possible to maintain the resolution of the display panel 106 as it is and thus to suppress the loss of light flux. When increasing the light flux to be transmitted at the sacrifice of the resolution, it is possible to assign each optical fiber 132a to a plurality of pixels. Conversely, using finer optical fibers 132a, it is possible to assign a plurality of optical fibers 132a to each pixel.

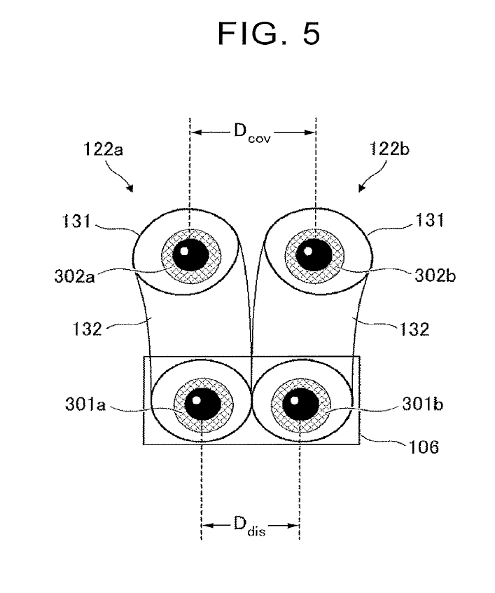

FIG. 5 is a schematic diagram showing another example of an eye portion 122. The eye portion 122 shown in FIG. 1 is formed by the right eye 122a described with reference to FIG. 3 and the left eye 122b having the same independent structure and disposed adjacent to the right eye 122a. The eye portion 122 of the example of FIG. 5 is configured such that a right eye 122a and a left eye 122b share a single display panel 106.

That is, the shared single display panel 106 displays both a display right eye diagram 301a and a display left eye diagram 301b. A right-eye optical fiber bundle 132 and a left-eye optical fiber bundle 132 are disposed adjacent to each other on a surface of the display panel 106. The light flux of the display right eye diagram 301a passes through the right-eye optical fiber bundle 132 and forms a projection right eye diagram 302a, while the light flux of the display left eye diagram 301b passes through the left-eye optical fiber bundle 132 and forms a projection left eye diagram 302b.

Normally, in a face portion 120, the right eye 122a and the left eye 122b are disposed to be spaced apart from each other. D_{cov} being a distance between the center of the projection right eye diagram 302a observed as a right eye and the center of the projection left eye diagram 302b observed as a left eye is longer than D_{dis} being a distance between the center of the display right eye diagram 301a and the center of the display left eye diagram 301b that are displayed on the display panel 106. That is, by slightly bending the optical fiber bundles 132 respectively connecting the display panel 106 and light-transmissive covers 131, the display panel 106 that is employed is minimized in size.

By employing such a structure, it is possible to achieve simplification of the assembly process and miniaturization of the display panel 106. While FIG. 5 shows the layout where the optical fiber bundles 132 are away from each other in opposite directions, the display panel 106 may be disposed at an arbitrary position using the flexibility of optical fibers.

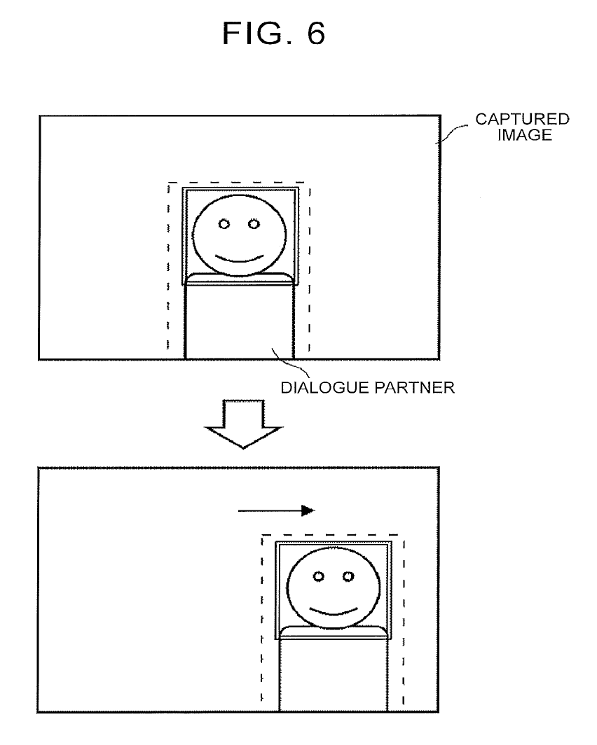

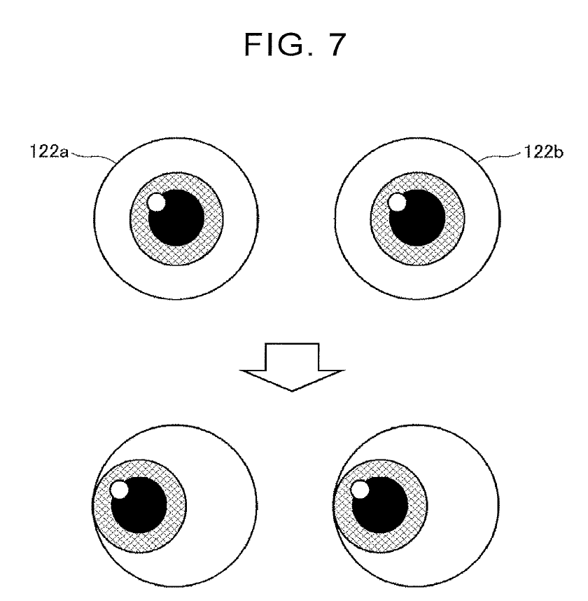

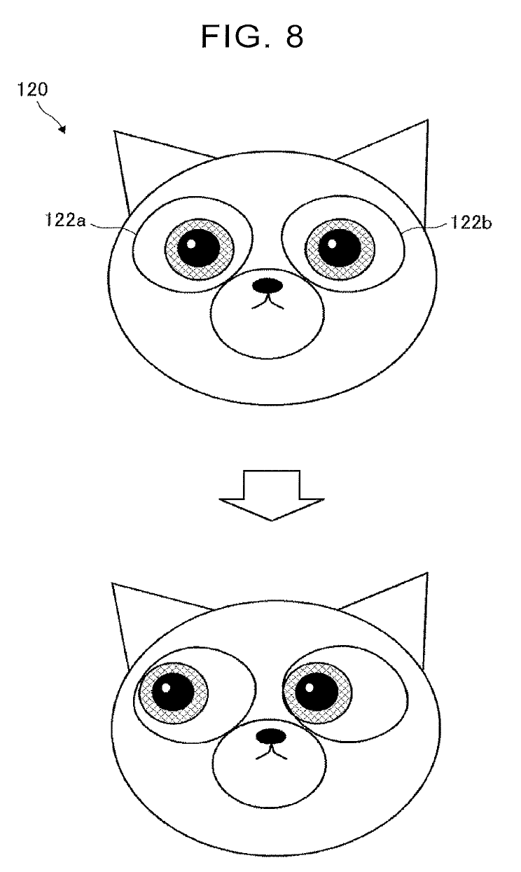

Next, the motion of the robot 100, as the communication device, having the eye portion 122 described above will be described. FIG. 6 is a diagram showing a state where a user has moved to the right side in a captured image. When the position of a face of the user being a dialogue partner has moved, the robot 100 directs the line of sight toward a direction in which the dialogue partner has moved. For example, when the user has moved to the right side in the captured image so that the position of the face of the user has moved to the right side in the captured image, the eye control unit 105, as shown in FIG. 7, moves the black eyes of the robot 100 to the right side stepwise so that the line of sight of the robot 100 looks like moving to the right side. The entire face portion 120 of the robot 100 in this event is observed, for example, as shown in FIG. 8.

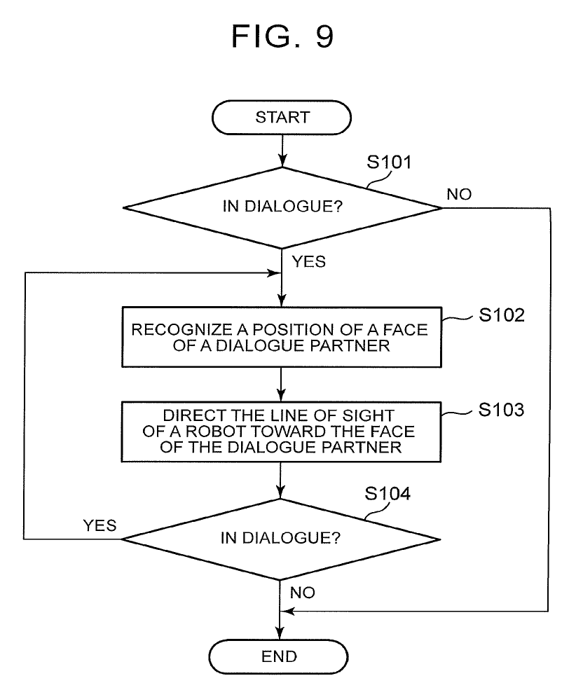

FIG. 9 is a flowchart showing the sequence of the display process. When the display process has started, the dialogue determination unit 103 determines at step S101 whether or not the robot 100 is in dialogue with a user. When it is not determined at step S101 that the robot 100 is in dialogue (NO at step S101), the display process is ended.

On the other hand, when it is determined at step S101 that the robot 100 is in dialogue (YES at step S101), the face recognition unit 110, at step S102, recognizes a position of a face of the user appearing in a captured image captured by the camera 102. Then, at step S103, based on the position of the face of the user recognized by the face recognition unit 110, the eye control unit 105 directs the line of sight of the eyes of the robot 100, that are displayed on the display panel/panels 106, toward the position of the face of the user.

Then, at step S104, the dialogue determination unit 103 again determines whether or not the robot 100 is in dialogue with the user. When it is not determined at step S104 that the robot 100 is in dialogue (NO at step S104), the display process is ended. On the other hand, when it is determined at step S104 that the robot 100 is in dialogue (YES at step S104), the display process returns to step S102 so that the processes of step S102 and subsequent steps are performed.

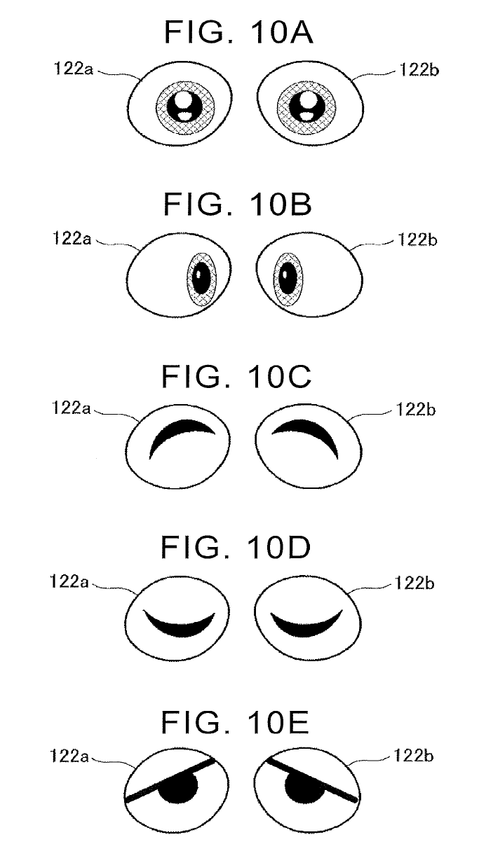

There are various designs in which expression of the eyes to be displayed on the display panel/panels 106 is stylized. FIGS. 10A to 10E are diagrams for explaining variations of designs to be displayed.

In the above, the description has been made that, in order to express the line of sight, the design is updated successively so as to move the daubed black eyes. However, expression of the eyes is not limited to the line of sight, and the eyes can also express various feelings. For example, a design shown in FIG. 10A emphasizes catchlight on irises and expresses, for example, an emotion.

A design shown in FIG. 10B is crossed eyes and expresses, for example, a doubtful feeling. In addition, a design that expresses a joyful feeling (FIG. 10C) and a design that expresses a sleepy feeling (FIG. 10D) can also be employed as designs that show expression of the eyes. A design to be displayed is not limited to an element of an eyeball, and, for example, as shown in FIG. 10E, it may be a design including an eyelid.

According to a state of a user, a dialogue content, and a surrounding environment, the eye control unit 105 selects one of these pre-prepared designs and displays it at a proper position of the display panel/panels 106 as appropriate. By the synergistic effect of such display control and the structure of the eye portion 122 described above, it is possible to provide a robot, as a communication device, with higher visibility and excellent expression ability.

What is claimed is:

1. A communication device comprising:
a face portion having a pair of eye portions;
light-transmissive covers each covering a corresponding one of the pair of eye portions;
a display panel configured to display a design in which expression of an eye is stylized;
an optical fiber bundle configured to transmit the design displayed on the display panel to the light-transmissive covers; and
a control unit configured to selectively display the design on the display panel.

2. The communication device according to claim 1, wherein
the display panel includes a plurality of pixels, and
the optical fiber bundle includes a plurality of optical fibers corresponding to the plurality of pixels.

3. The communication device according to claim 1, wherein
each of the light-transmissive covers has a curved surface, and
a region, corresponding to the curved surface, of an end face of the optical fiber bundle on a light-transmissive cover side is processed to match the curved surface.

4. The communication device according to claim 1, wherein
the display panel is formed by a single panel configured to display two designs that are respectively projected onto the light-transmissive covers.

5. The communication device according to claim 1, wherein
the control unit is configured to change the design according to a change in surrounding environment of the communication device.

6. The communication device according to claim 1, wherein
one end of the optical fiber bundle is bonded to a surface of the display panel by a light-guide adhesive, and
the other end of the optical fiber bundle is bonded to inner surfaces of the light-transmissive covers by a light-guide adhesive.

7. The communication device according to claim 1, wherein
an outer peripheral surface of the optical fiber bundle is coated with a light-shielding material.

8. The communication device according to claim 2, wherein
the plurality of optical fibers are in one-to-one correspondence with the plurality of pixels.

9. The communication device according to claim 8, wherein
the plurality of pixels are arranged two-dimensionally in a grid pattern, and
the optical fibers are arranged so as to be respectively inscribed in the pixels.

10. The communication device according to claim 2, wherein
each of the optical fibers corresponds to a plurality of the pixels.

11. The communication device according to claim 2, wherein
a plurality of the optical fibers correspond to each of the pixels.
